(19) United States
(12) Patent Application Publication
(10) Pub. No.: US 2022/0271296 A1
(43) Pub. Date: Aug. 25, 2022

(54) COMPOSITE ACTIVE MATERIAL PARTICLE, CATHODE, ALL-SOLID-STATE LITHIUM ION BATTERY, AND METHODS FOR PRODUCING THE SAME

(71) Applicant: TOYOTA JIDOSHA KABUSHIKI KAISHA, Toyota-shi (JP)

(72) Inventor: Nariaki MIKI, Susono-shi (JP)

(73) Assignee: TOYOTA JIDOSHA KABUSHIKI KAISHA, Toyota-shi (JP)

(21) Appl. No.: 17/738,497

(22) Filed: May 6, 2022

Related U.S. Application Data
(62) Division of application No. 15/864,182, filed on Jan. 8, 2018.

(30) Foreign Application Priority Data
Feb. 2, 2017 (JP) 2017-017794

(51) Int. Cl. H01M 4/88; H01M 4/36; H01M 10/0525; H01M 4/525; H01M 4/62; H01M 10/0562; H01M 4/505

(52) U.S. Cl. CPC H01M 4/8882; H01M 4/364; H01M 10/0525; H01M 4/525; H01M 4/62; H01M 4/366; H01M 10/0562; H01M 4/505; C08K 2003/2258

(57) ABSTRACT

A composite active material particle that can reduce battery resistance when used in an all-solid-state lithium ion battery is disclosed. The composite active material particle comprises: an active material particle; and a lithium ion conducting oxide with which at least part of a surface of the active material particle is coated, wherein the moisture content in the composite active material particle is no more than 319 ppm.

### CROSS-REFERENCE TO RELATED PATENT APPLICATION

This application is a divisional of U.S. application Ser. No. 15/864,182 filed Jan. 8, 2018, which claims benefit of priority of Japanese Patent Application No. 2017-017794, filed on Feb. 2, 2017. The entire disclosures of the prior applications including the specification, drawings, and abstract are incorporated herein by reference in their entirety.

### FIELD

The present application discloses a composite active material particle, a cathode, an all-solid-state lithium ion battery, and methods for producing the same.

### BACKGROUND

Patent Literature 1 discloses a problem in an all-solid-state lithium ion battery using a sulfide solid electrolyte that a high-resistance layer is formed at the interface at which the sulfide solid electrolyte contacts a positive electrode active material, and output performance of the battery decreases, and discloses, as a solution to this problem, that the positive electrode active material surface is coated with a lithium ion-conducting oxide, to be a composite active material particle. In Patent Literature 1, solution that contains elements to constitute a coating layer of the lithium ion-conducting oxide is applied on the positive electrode active material surface, and is heated at a temperature of 400° C. or lower, to obtain the composite active material particle.

Patent Literature 2 discloses a problem that when the surface of a positive electrode active material is coated with lithium niobate that is a lithium ion conductive oxide, to be a composite active material particle, the electric resistance value of the composite active material particle itself is increased although it is possible to prevent the formation of a high resistance layer on the interface at which a sulfide solid electrolyte contacts the positive electrode active material, and discloses, as a solution to this problem, that the carbon content in the composite active material particle is reduced. In Patent Literature 2, the positive electrode active material, and an aqueous solution containing a niobium compound and a lithium compound are mixed, the niobium compound and the lithium compound are adhered to the surface of the positive electrode active material, and then heat treatment is carried out at 300° C. to 700° C., to obtain the composite active material particle.

Patent Literature 3 discloses a technique of using a positive electrode active material grain having a predetermined specific surface area, and a predetermined moisture value or less for concurrently realizing a low self-discharge rate and a high recovery factor in a nonaqueous electrolyte secondary battery, which is not a technique relating to all-solid-state batteries though.

### CITATION LIST

### Patent Literature

Patent Literature 1: WO2007/004590A1
Patent Literature 1: JP2012-074240A
Patent Literature 3: JP H10-149832A

### SUMMARY

### Technical Problem

As described above, various studies have been done on a composite active material particle for all-solid-state lithium ion batteries. Performance of all-solid-state lithium ion batteries is being improved day by day. However, battery resistance of all-solid-state lithium ion batteries is still high even if a composite active material particle as disclosed in Patent Literatures 1 or 2 is used, and it is hard to say that performance of all-solid-state lithium ion batteries is sufficient.

The present application discloses a composite active material particle that can reduce battery resistance when the composite active material particle is used in an all-solid-state lithium ion battery.

### Solution to Problem

The inventor of this application intensively researched factors in the increase of battery resistance of all-solid-state lithium ion batteries, and found that an extremely small amount of moisture contained in a composite active material particle reacts with, and deteriorates a sulfide solid electrolyte, whereby resistance of an all-solid-state lithium ion battery is increased. Based on this finding, the inventor of this application assumed that when a composite active material particle was produced, a process for largely reducing the moisture content in the particle was necessary, and pursued further research. As a result, he found that when a composite active material particle is produced, the moisture content in the composite active material particle can be largely reduced by vacuum drying under predetermined conditions. As he produced an all-solid-state lithium ion battery using a composite active material particle that was produced in the above described way, an all-solid-state lithium ion battery of low battery resistance could be obtained.

Based on the above findings, the present application discloses a composite active material particle comprising: an active material particle; and a lithium ion conducting oxide with which at least part of a surface of the active material particle is coated, wherein a moisture content in the composite active material particle is no more than 319 ppm, as one means for solving the above problems.

“Active material particle” has only to have a normal size so as to be usable as active material for all-solid-state lithium ion batteries.

“Lithium ion conducting oxide”, having lithium ion conductivity, functions as protective material for suppressing reaction of the active material particle with the sulfide solid electrolyte. That is, “lithium ion conducting oxide” is an oxide having lithium ion conductivity, and relatively low reactivity to the sulfide solid electrolyte compared with that the active material particle has.

“A moisture content in the composite active material particle is no more than 319 ppm” means that a percent concentration by mass of moisture contained in the composite active material particle is no more than 319 ppm. “Moisture content” in the composite active material particle can be measured by Karl Fischer titration.

In the composite active material particle of the present disclosure, preferably, the lithium ion conducting oxide is at least one selected from lithium niobate, lithium titanate, lithium lanthanum zirconate, lithium tantalate, and lithium tungstate.

The present application discloses a cathode mixture layer that contains the composite active material particle according to the above described present disclosure, and a sulfide solid electrolyte, as one means for solving the above problems.

The present application discloses an all-solid state lithium ion battery comprising: the cathode according to the above described present disclosure; a solid electrolyte layer; and an anode, as one means for solving the above problems.

The present application discloses a method for producing a composite active material particle, the method comprising: a first step of coating at least part of a surface of an active material particle with a lithium ion conducting oxide, to form a coated active material particle; and a second step of drying the coated active material particle obtained in the first step in a vacuum at a temperature of 120° C. to 300° C. for at least 1 hour, as one means for solving the above problems.

“Vacuum drying” is extracting moisture from the composite active material particle by decompressing pressure to be a reduced pressure of 100 kPa or less.

In the first step according to the method for producing a composite active material particle of the present disclosure, preferably, a peroxo complex aqueous solution that contains (an) element(s) constituting the lithium ion conducting oxide is dried on the surface of the active material particle, to obtain a precursor, and the precursor is calcined to form the coated active material particle.

The present application discloses a method for producing a cathode, the method comprising: a step of obtaining a cathode mixture by mixing the composite active material particle produced by the method for producing a composite active material particle of the present disclosure, with a sulfide solid electrolyte; and a step of shaping the cathode mixture, as one means for solving the above problems.

The present application discloses a method for producing an all-solid-state lithium ion battery, the method comprising: a step of layering the cathode produced by the method according to the method for producing a cathode of the present disclosure, a solid electrolyte layer, and an anode, as one means for solving the above problems.

### Advantageous Effects

The moisture content in the composite active material particle of this disclosure is extremely small. Whereby, when this composite active material particle is employed to an all-solid-state lithium ion battery, deterioration of a sulfide solid electrolyte due to moisture contained in the composite active material particle can be suppressed, and conductivity of the sulfide solid electrolyte is kept high. Whereby, an-all-solid-state lithium ion battery of low battery resistance can be obtained.

### BRIEF DESCRIPTION OF DRAWINGS

FIG. 1 is an explanatory schematic view of the structure of a composite active material particle 10;

FIG. 2 is an explanatory schematic view of the structure of a cathode 20;

FIG. 3 is an explanatory schematic view of the structure of an all-solid-state lithium ion battery 100;

FIG. 4 is an explanatory view of the flow of a method for producing a composite active material particle (S10);

FIG. 5 is an explanatory view of the flow of a method for producing a cathode (S20); and

FIG. 6 is an explanatory view of the flow of a method for producing an all-solid-state lithium ion battery (S100).

### DETAILED DESCRIPTION OF EMBODIMENTS

1. Composite Active Material Particle

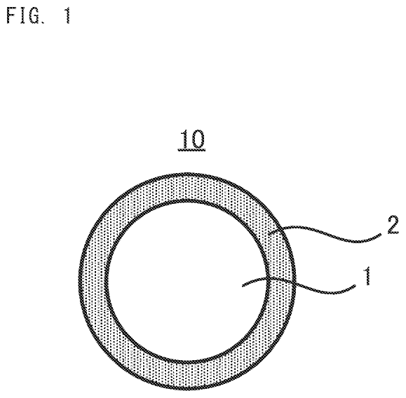

FIG. 1 is a schematic view of the structure of a composite active material particle 10. FIG. 1 schematically shows one grain of the composite active material particle 10, which is extracted. As shown in FIG. 1, the composite active material particle 10 has an active material particle 1, and a lithium ion conducting oxide 2 with which at least part of the surface of the active material particle 1 is coated. Here, a feature of the composite active material particle 10 is that the moisture content therein is no more than 319 ppm.

1.1. Active Material Particle

A feature of the composite active material particle 10 is that the moisture content therein is extremely small. If only this condition is satisfied, the desired effect is shown, and the above problems can be solved. Therefore, there is no any limitation on a type of the active material particle 1. Any particle consisting of material usable as active material for all-solid-state lithium ion batteries can be employed. Examples of such material include LiCoO₂, LiNixCo₁₋ₓO₂ (0<x<1), LiNi_{1/3}Co_{1/3}Mn_{1/3}O₂, LiMnO₂, different kind element substituent Li—Mn spinels (LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄), lithium titanate (such as Li₄Ti₅O₁₂), lithium metal phosphates (LiFePO₄, LiMnPO₄, LiCoPO₄, and LiNiPO₄), transition metal oxides (V₂O₅, and MoO₃), TiS₂, carbon material such as graphite and hard carbon, LiCoN, Si, SiO₂, Li₂SiO₃, Li₄SiO₄, lithium metal (Li), lithium alloys (LiSn, LiSi, LiAl, LiGe, LiSb, and LiP), and lithium storage intermetallic compounds (such as Mg₂Sn, Mg₂Ge, Mg₂Sb, and Cu₃Sb). Here, two materials that are different in potential at which lithium ions are stored and released (charge-discharge potential) are selected from the above described materials. One material showing noble potential can be used as cathode active material, and the other material showing base potential can be used as anode active material, which makes it possible to compose an all-solid-state lithium ion battery of any potential. Specifically, the active material particle 1 is preferably a cathode active material particle, and more preferably a particle of a lithium-containing composite oxide selected from LiCoO₂, LiNiₓCo₁₋ₓO₂ (0<x<1), LiNi_{1/3}Co_{1/3}Mn_{1/3}O₂, LiMnO₂, different kind element substituent Li—Mn spinels, lithium metal phosphates, and so on. The embodiment of the active material particle 1 is not restricted as long as the active material particle 1 can constitute the composite active material particle 10. A primary particle diameter thereof is preferably 1 nm to 100 μm. The lower limit thereof is more preferably no less than 10 nm, further preferably no less than 100 nm, and especially preferably no less than 500 nm. The upper limit thereof is more preferably no more than 30 μm, and further preferably no more than 3 μm. Cohering primary particles of the active material particles 1 as the above may constitute a secondary particle.

1.2. Lithium Ion Conducting Oxide

The lithium ion conducting oxide 2, having lithium ion conductivity, functions as protective material for suppressing reaction of the active material particle 1 with a sulfide solid electrolyte 11 described later. Any type of the lithium ion conducting oxide 2 brings about the desired effect, and the above problems can be solved as long as having such a function. Examples of the lithium ion conducting oxide 2 include composite oxides containing a lithium element and a metallic element. Specific examples thereof include lithium niobate, lithium titanate, lithium lanthanum zirconate, lithium tantalate, and lithium tungstate. Among them, lithium niobate is preferable in view of further reducing reaction resistance of the active material particle 1 with the sulfide solid electrolyte 11 described later. In the composite active material particle 10, no less than 90 mass % of such a lithium ion conducting oxide is preferably contained in a coating layer of the lithium ion conducting oxide 2. The upper limit thereof is not restricted, and for example, no more than 99 mass %. The thickness of the coating layer is not restricted, and is preferably 3 nm to 100 nm in view of further reduction of the reaction resistance.

1.3. Moisture Content

It is important that the moisture content in the composite active material particle 10 is no more than 319 ppm. The moisture content in the composite active material particle 10 is preferably no more than 119 ppm, and more preferably no more than 70 ppm. An extremely small moisture content in the particle as described above makes it possible to suppress deterioration of the sulfide solid electrolyte 11 described later due to moisture contained in the composite active material particle 10, and conductivity of the sulfide solid electrolyte 11 is kept high when the particle is applied to an all-solid-state lithium ion battery. That is, using the composite active material particle 10 leads to obtainment of an all-solid-state lithium ion battery of low battery resistance.

2. Cathode

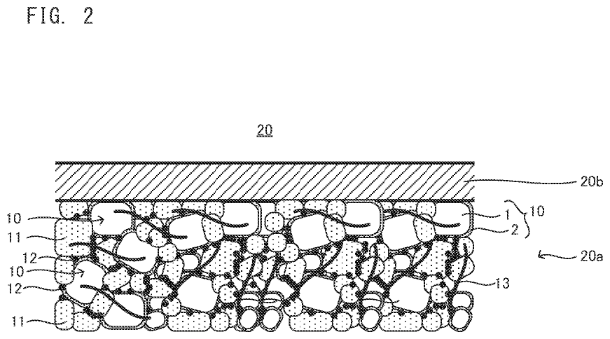

FIG. 2 is a schematic view of the structure of a cathode 20. As shown in FIG. 2, the cathode 20 has a cathode mixture layer 20a that includes the composite active material particle 10 and the sulfide solid electrolyte 11. The cathode mixture layer 20a may contain conductive material 12, and a binder 13 as optional components. Further, the cathode 20 may be provided with a cathode collector 20b that is electrically connected to the cathode mixture layer 20a.

2.1. Composite Active Material Particle

The cathode mixture layer 20a of the cathode 20 contains the composite active material particle 10 as cathode active material. Two materials that are different in potential at which lithium ions are stored and released (charge-discharge potential) are selected from the materials that are described above as specific examples of the active material particle 1. One material showing noble potential can be used as the active material particle 1, and the other material showing base potential can be used as anode active material described below. The content of the composite active material particle 10 in the cathode mixture layer 20a is not restricted, and preferably, for example, 40% to 99% by mass.

2.2. Sulfide Solid Electrolyte

The cathode mixture layer 20a of the cathode 20 contains the sulfide solid electrolyte 11. The sulfide solid electrolyte 11 is partially in contact with the composite active material particle 10. Examples of the sulfide solid electrolyte 11 that the cathode mixture layer 20a can contain include Li₂S—SiS₂, LiI—Li₂S—Si₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, and Li₃PS₄. The sulfide solid electrolyte 11 may be either amorphous or crystalline. The content of the sulfide solid electrolyte 11 in the cathode mixture layer 20a is not restricted.

2.3. Other Components

The cathode mixture layer 20a of the cathode 20 may contain the conductive material 12 as an optional component. Examples of the conductive material 12 that the cathode mixture layer 20a can contain include carbon material such as vapor grown carbon fibers, acetylene black (AB), Ketjen black (KB), carbon nanotubes (CNT), and carbon nanofibers (CNF), and other metallic material that can bear an environment where an all-solid-state lithium ion battery is to be used. The content of the conductive material 12 in the cathode mixture layer 20a is not restricted.

The cathode mixture layer 20a of the cathode 20 may contain the binder 13 as an optional component. Examples of the binder 13 that the cathode mixture layer 20a can contain include acrylonitrile-butadiene rubber (ABR), butadiene rubber (BR), polyvinylidene fluoride (PVdF), and styrene-butadiene rubber (SBR). The content of the binder 13 in the cathode mixture layer 20a is not restricted.

It is noted that the cathode mixture layer 20a of the cathode 20 may contain any other solid electrolytes in addition to the sulfide solid electrolyte 11 as long as the desired effect is not ruined. For example, an oxide solid electrolyte may be contained. An oxide solid electrolyte in this case is an oxide solid electrolyte that does not constitute the coating layer of the composite active material particle 10. The content of solid electrolytes other than the sulfide solid electrolyte in the cathode mixture layer 20a is not restricted.

The thickness of the cathode mixture layer 20a in the cathode 20 is not restricted. The thickness thereof may be properly determined according to the performance to be aimed.

2.4. Cathode Collector

The cathode 20 preferably has the cathode collector 20b that is in contact with the cathode mixture layer 20a. Any known metals that are usable as collectors for all-solid-state lithium ion batteries can be used as the cathode collector 20b. Examples of such metals include metallic material containing one or at least two elements selected from the group consisting of Cu, Ni, Al, V, Au, Pt, Mg, Fe, Ti, Co, Cr, Zn, Ge, and In. The embodiment of the cathode collector 20b is not restricted. Various embodiments such as foil and mesh can be taken.

The shape of the cathode 20 as a whole is not restricted, and is preferably a sheet as shown in FIG. 2. In this case, the thickness of the cathode 20 as a whole is not restricted. The thickness thereof may be properly determined according to the performance to be aimed.

As described above, the cathode 20 includes the composite active material particle 10 and the sulfide solid electrolyte 11 in the cathode mixture layer 20a. Here, an extremely small moisture content in the composite active material particle 10 in the cathode 20 as described above makes it possible to suppress deterioration of the sulfide solid electrolyte 11 due to moisture contained in the composite active material particle 10, and conductivity of the sulfide solid electrolyte 11 is kept high. Whereby, the cathode of low resistance can be obtained.

3. All-Solid-State Lithium Ion Battery

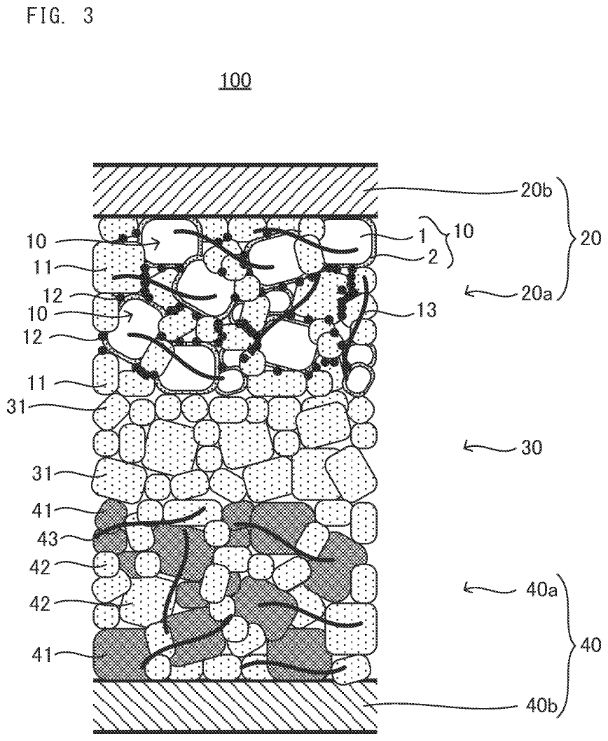

FIG. 3 is a schematic view of the structure of an all-solid-state lithium ion battery 100. As shown in FIG. 3, the all-solid-state lithium ion battery 100 includes the cathode 20, a solid electrolyte layer 30, and an anode 40.

3.1. Cathode

The structure of the cathode 20 is as described above.

3.2. Solid Electrolyte Layer

The solid electrolyte layer 30 includes a solid electrolyte 31. Any known solid electrolyte usable in all-solid-state lithium ion batteries can be properly used as the solid electrolyte 31 that the solid electrolyte layer 30 contains. Examples of such a solid electrolyte include solid electrolytes that the cathode 20, and the anode 40 described later can contain. Preferably, the content of the solid electrolyte 31 in the solid electrolyte layer 30 is, for example, no less than 60%, moreover no less than 70%, and especially no less than 80% by mass.

The solid electrolyte layer 30 can contain any binder that binds the solid electrolytes 31 with each other, which is not shown in FIG. 3, in view of showing plasticity etc. Examples of such a binder include binders that the cathode 20, and the anode 40 described later can contain. It is noted that a binder that the solid electrolyte layer 30 contains is preferably no more than 5 mass % in view of preventing the solid electrolytes 31 from excessively cohering, and making it possible to form the solid electrolyte layer 30 having the uniformly dispersed solid electrolytes 31, for facilitating high power output.

The shape of the solid electrolyte layer 30 is not restricted, and is preferably a sheet as shown in FIG. 3. In this case, the thickness of the solid electrolyte layer 30 is not restricted. The thickness thereof may be determined properly according to the performance to be aimed.

3.3. Anode

The anode 40 has an anode mixture layer 40a that includes anode active material 41. The anode mixture layer 40a may contain a solid electrolyte 42, a binder 43, and conductive material (not shown) as optional components. Further, the anode 40 may be provided with an anode collector 40b that is in contact with the anode mixture layer 40a.

The anode mixture layer 40a of the anode 40 includes the anode active material 41. Two materials that are different in potential at which lithium ions are stored and released (charge-discharge potential) are selected from the materials that are described above as specific examples of the active material particle 1. One material showing noble potential can be used as the active material particle 1, and the other material showing base potential can be used as the anode active material 41. The shape of the anode active material 41 is not restricted, and examples thereof include a particle, and a thin film. The average particle diameter (D₅₀) of the anode active material 41 is, for example, preferably 1 nm to 100 μm, and more preferably 10 nm to 30 μm. The content of the anode active material 41 in the anode mixture layer 40a is not restricted, and, preferably, for example, 40% to 99% by mass.

The anode mixture layer 40a of the cathode 40 may contain the known solid electrolyte 42 as an optional component. Examples of the solid electrolyte 42 include sulfide solid electrolytes, and oxide solid electrolytes as described above. The solid electrolyte 42 may be either amorphous or crystalline. The content of the solid electrolyte 42 in the anode mixture layer 40a is not restricted.

The anode mixture layer 40a of the anode 40 may contain the binder 43, and conductive material as optional components. The binder 43, and the conductive material may be properly selected from the examples indicated since the examples can be used as the cathode mixture layer 20a. The contents of the binder 43, and the conductive material in the anode mixture layer 40a are not restricted.

In the anode 40, the thickness of the anode mixture layer 40a is not restricted. The thickness thereof may be properly determined according to the performance to be aimed.

The anode 40 preferably has the anode collector 40b that is in contact with the anode mixture layer 40a. Any known metals usable as collectors for all-solid-state lithium ion batteries can be used as the anode collector 40b. Examples of such metals include metallic material containing one or at least two elements selected from the group consisting of Cu, Ni, Al, V, Au, Pt, Mg, Fe, Ti, Co, Cr, Zn, Ge, and In. The embodiment of the anode collector 40b is not restricted. Various embodiments such as foil and mesh can be taken.

The shape of the anode 40 as a whole is not restricted, and is preferably a sheet as shown in FIG. 3. In this case, the thickness of the anode 40 as a whole is not restricted. The thickness thereof may be properly determined according to the performance to be aimed.

As described above, the all-solid-state lithium ion battery 100 includes the composite active material particle 10 and the sulfide solid electrolyte 11 in the cathode mixture layer 20a of the cathode 20. Here, an extremely small moisture content in the composite active material particle 10 as described above in the all-solid-state lithium ion battery 100 makes it possible to suppress deterioration of the sulfide solid electrolyte 11 in the cathode mixture layer 20a etc. due to moisture contained in the composite active material particle 10, and conductivity of the sulfide solid electrolyte 11 is kept high. Whereby, the all-solid-state lithium ion battery 100 of low resistance can be obtained.

4. Method for Producing Composite Active Material Particle

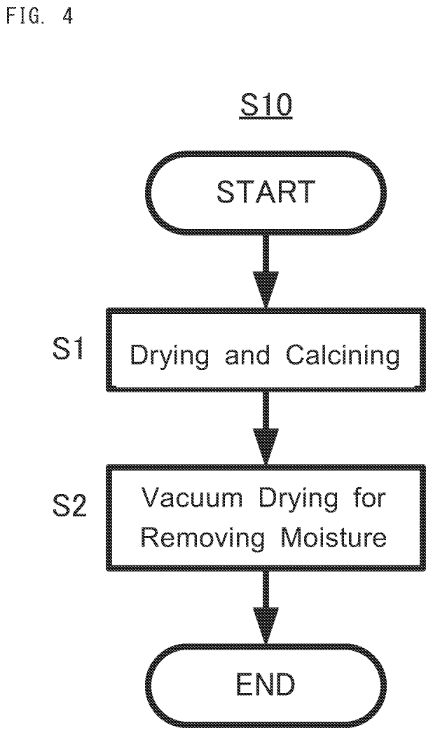

FIG. 4 shows the flow of a method for producing the composite active material particle S10. As shown in FIG. 4, S10 includes a first step S1 of coating at least part of the surface of the active material particle with the lithium ion conducting oxide, to form a coated active material; and a second step S2 of drying the coated active material in a vacuum at a temperature of 120° C. to 300° C. for at least 1 hour.

4.1. First Step S1

In the first step, at least part of the surface of the active material particle is coated with the lithium ion conducting oxide, to form the coated active material particle. For example, after the surface of the active material particle is coated with a solution by a method of immersing the active material particle in the solution that contains elements constituting the lithium ion conducting oxide, or spraying the solution that contains elements constituting the lithium ion conducting oxide in the state where the active material particle is fluidized, or the like, the solution is removed by drying, and the resultant is properly heat-treated, to obtain the coated active material particle. A peroxo complex aqueous solution or an alkoxide solution is used as the solution. When a peroxo complex aqueous solution is used, for example, the step 1 can be carried out with a procedure as disclosed in JP2012-74240A, JP 2016-170973A, etc. When an alkoxide solution is used, for example, the step 1 can be carried out with a procedure as disclosed in WO2007/004590A1, JP2015-201252A, etc.

Hereinafter the embodiment that in the first step, a peroxo complex aqueous solution that contains (an) element(s) constituting the lithium ion conducting oxide is dried on the surface of the active material particle, to obtain the precursor (drying step), and the precursor is calcined to form the coated active material particle (calcining step) will be described as a preferred embodiment.

In the drying step, the peroxo complex aqueous solution that contains (an) element(s) constituting the lithium ion conducting oxide is dried on the surface of the active material particle, to obtain the precursor. That is, drying is carried out in the state where the peroxo complex aqueous solution is in contact with the surface of the active material particle. A method for making the peroxo complex aqueous solution be in contact with the surface of the active material particle is the above described immersion, or spraying. Spraying is especially preferable. When lithium niobate is employed as the lithium ion conducting oxide, the peroxo complex aqueous solution contains a peroxo complex of lithium and niobium. Specifically, after a transparent solution is made by using a hydrogen peroxide solution, niobic acid, and ammonia water, a lithium salt is added to the made transparent solution, to obtain the peroxo complex aqueous solution. In this case, even if the moisture content in niobic acid varies, a peroxo complex of niobate can be formed. Thus, the moisture content in niobic acid is not restricted. As long as a peroxo complex of niobium can be synthesized, the mixing ratio of niobic acid to ammonia water is not restricted. Examples of a lithium salt include LiOH, LiNO₃, and Li₂SO₄. A lithium salt may be a hydrate.

In the drying step, the above described complex solution is made to be in contact with the surface of the active material particle. Then, volatile components such as a solvent and a hydrated water which the complex solution being in contact with the surface of the active material particle contains are removed by drying. Such a step can be carried out by, for example, using a tumbling fluidized coating device, a spray dryer, or the like. Examples of a tumbling fluidized coating device include Multiplex manufactured by Powrex Corporation, and Flow Coater manufactured by Freund Corporation. When a tumbling fluidized coating device is used, and when one grain of the active material particle is focused on, just after the complex solution is supplied (sprayed) to the surface of the active material particle, the complex solution is dried. After that, the supply of the complex solution to the active material, and drying of the complex solution that is supplied to the active material are repeated until the thickness of a layer of a precursor of lithium niobate that is attached to the surface of the active material is the thickness to be aimed. When a tumbling fluidized coating device is used, and when a plurality of grains of the active material particles exiting in the device are focused on, active material particles, to which the complex solution is supplied (sprayed), and active material particles, the complex solution over the surfaces of which is being dried, coexist. As described above, when a tumbling fluidized coating device is used, the complex solution is supplied (sprayed) to the surface of the active material particle, and at the same time, the complex solution attached to the surface of the active material particle can be dried. Drying temperature in the spraying and drying step is not restricted. An atmosphere (carrier gas) in the spraying and drying step is not restricted as well.

In the calcining step, the precursor obtained in the drying step is calcined at a predetermined temperature. Whereby, the coated active material particle that is constituted by coating at least part of the surface of the active material particle with the lithium ion conducting oxide is obtained. For example, the calcining step can be carried out in the atmosphere. A calcining temperature in the calcining step may be same as conventional methods.

4.2. Second Step S2

According to a finding of the inventor of the present application, when the peroxo complex aqueous solution is used in the first step, the moisture content in the coated active material particle cannot be reduced enough even if the above described drying step and calcining step are carried out. According to a finding of the inventor of the present application, when an alkoxide solution is used in the first step, the moisture content in the coated active material particle cannot be reduced enough as well even if the above described drying step and calcining step are carried out because hydrolysis reaction for forming the lithium ion conducting oxide is essential and thus, a large amount of moisture is generated and remains in the coated active material particle. As described above, a certain amount or more of moisture exists inside the coated active material particle obtained in the first step. Therefore, in the producing method S10, moisture is properly removed from the coated active material particle by carrying out the second step in addition to the first step.

That is, the producing method S10 has a feature that in the second step, the coated active material particle obtained in the first step is dried in a vacuum at 120° C. to 300° C. for at least 1 hour.

The drying temperature in the second step has to be no less than 120° C., and is preferably no less than 200° C. If the temperature is too low, moisture cannot be removed efficiently from the coated active material particle.

The temperature in the second step has to be no more than 300° C., and is preferably no more than 250° C. According to a finding of the inventor of the present application, if the temperature is too high, crystallization of the lithium ion conducting oxide progresses, and in some cases, water is generated from the inside of the structure, which leads to increase of the moisture content conversely. When crystallization of the lithium ion conducting oxide progresses, the resistance of the composite active material particle itself might increase as well.

The drying time in the second step has to be no less than 1 hour, and preferably no less than 5 hours. If the drying time is too short, it becomes difficult that moisture is properly removed from the coated active material particle. The upper limit of the drying time is not restricted, and for example, preferably no more than 10 hours.

In the second step, the coated active material particle has to be dried in a vacuum. Vacuum drying is extracting moisture from the coated active material particle by decompressing pressure to be a reduced pressure of 100 kPa or less. The pressure is preferably no more than 50 kPa, and more preferably no more than 5 kPa. For example, the second step can be carried out by using a nonexposure vacuum drying apparatus. Specifically, the second step can be carried out by various methods such as using an open vacuum drying apparatus in a glove box, and heating with a furnace while being subject to evacuation in a closed system.

As described above, according to the producing method S10, the composite active material particle, the moisture content in which is largely reduced, can be obtained through the first step S1 and the second step S2. When this is applied to an all-solid-state lithium ion battery, deterioration of the sulfide solid electrolyte due to moisture contained in the composite active material particle can be suppressed, and conductivity of the sulfide solid electrolyte is kept high. That is, an all-solid-state lithium ion battery of low battery resistance is obtained.

5. Method for Producing Cathode

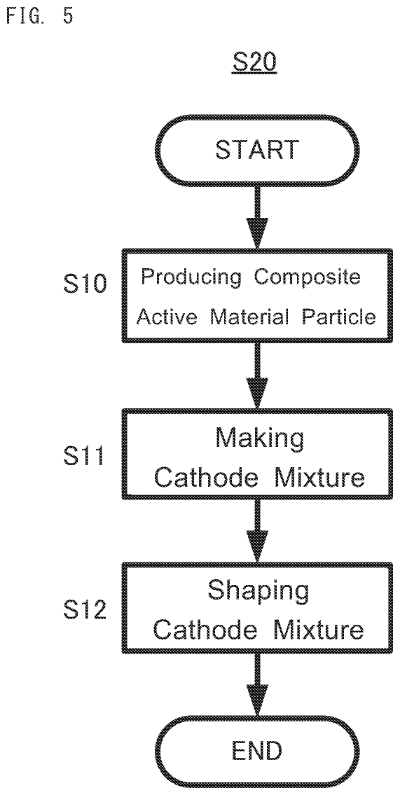

FIG. 5 shows the flow of a method for producing a cathode S20. As shown in FIG. 5, S20 includes a step of obtaining a cathode mixture by mixing the composite active material particle produced by the producing method S10, with the sulfide solid electrolyte S11; and a step of shaping the cathode mixture S12.

In the step S11, the cathode mixture is obtained by mixing the composite active material particle produced by the producing method S10, with the sulfide solid electrolyte. The composite active material particle and the sulfide solid electrolyte may be mixed in either a dry process, or a wet process using an organic solvent (preferably a nonpolar solvent). As described above, the cathode mixture may optionally contain conductive material, a binder, etc., in addition to the composite active material particle, and the sulfide solid electrolyte.

In the step S12, the cathode mixture obtained in the step S11 is shaped. The cathode mixture may be shaped in either a dry or wet process. The cathode mixture may be shaped either individually, or with the cathode collector. As described later, the cathode mixture may be subjected to integral molding on the surface of the solid electrolyte layer.

Specifically more detailed examples of the producing method S20 include the embodiment that: after loaded into a solvent, the composite active material particle, the sulfide solid electrolyte, and optionally a conductive additive and a binder are dispersed using an ultrasonic homogenizer or the like, whereby a slurry cathode composition is made; the surface of the cathode collector is coated with this composition; thereafter after a drying and optionally pressing process, the cathode is made. Or, the examples also include the embodiment of making the cathode by loading the cathode mixture of powder into a mold or the like, and carrying out dry press forming.

6. Method for Producing all-Solid-State Lithium Ion Battery

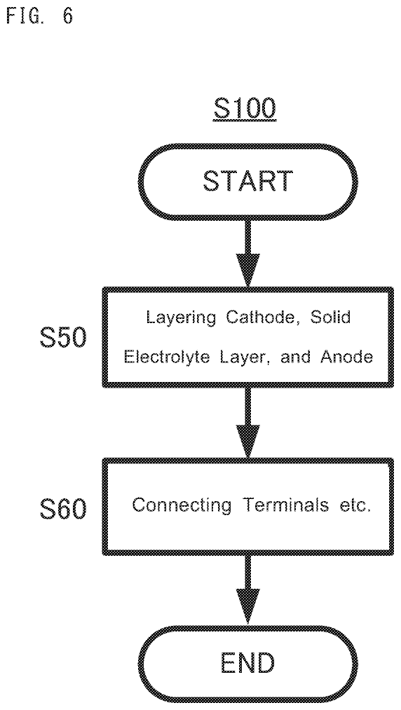

FIG. 6 shows the flow of a method for producing an all-solid-state lithium ion battery S100. As shown in FIG. 6, S100 includes a step of layering the cathode produced by the producing method S20, the solid electrolyte layer, and the anode S50. After that, after an obvious step S60 for composing all-solid-state lithium ion batteries such as connection of terminals, housing into a battery case, and constraint of a battery, the all-solid-state lithium ion battery is produced.

In the step S50, a plurality of the cathodes, the solid electrolyte layers, and the anodes may be layered. In the step S50, the cathode mixture, the solid electrolyte layer, and an anode mixture, which are powder, may be deposited, to be integrally molded all together.

7. Supplement

According to problems and solutions of the present application, when the composite active material particle is stored after produced in the producing method S10, it is necessary that the composite active material particle is stored without exposure to a high humidity atmosphere. It is also necessary to produce the cathode, and the all-solid-state lithium ion battery without exposing the composite active material particle to a high humidity atmosphere after producing the composite active material particle in the producing method S10. That is, it is good that the composite active material particle is stored, the cathode is produced, and the all-solid-state lithium ion battery is produced in the state where moisture in the system is removed as much as possible. For example, it is considered to be effective to reduce a pressure in the system, to replace the atmosphere in the system with gas such as an inert gas which does not substantially contain moisture, etc. in the storing or producing processes.

### EXAMPLES

Hereinafter, the effect of the composite active material particle of the present disclosure will be described further with the examples.

### 1. Preparing Peroxo Complex Solution

To 870.4 g of a hydrogen peroxide solution of 30 mass % in concentration, 987.4 g of ion-exchange water, and 44.2 g of niobic acid (Nb₂O₅.3H₂O, the content of Nb₂O₅: 72%) were added. Next, 87.9 g of ammonia water of 28 mass % in concentration was added, and enough stirred, to obtain a transparent solution. To the obtained transparent solution, 10.1 g of lithium hydroxide monohydrate (LiOH.H₂O) was added, to obtain a peroxo complex aqueous solution containing lithium and a niobium complex. The molar concentrations of Li, and Nb in the obtained peroxo complex aqueous solution were 0.12 mol/kg respectively.

### 2. Spraying Over and Calcining Active Material Particle

Using a coater (MP-01 manufactured by Powrex Corporation), 2840 g of the peroxo complex aqueous solution was sprayed over 1 kg of a cathode active material particle (LiNi_{1/3}Mn_{1/3}Co_{1/3}O₂), and the peroxo complex aqueous solution was attached to the surface of the active material particle. Driving conditions thereof were: nitrogen was used as an intake gas; intake gas temperature was 120° C.; the intake gas flow was 0.4 m³/min; the rotating speed of a rotor was 400 rpm; and the spraying speed was 4.8 g/min. After completion of the driving, calcining was performed in the atmosphere at 200° C. for 5 hours, to obtain a composite active material particle before removing moisture.

### 3. Removing Moisture

### 3.1. Example 1

The composite active material particle was subjected to vacuum drying at 200° C. for 1 hour at 5 kPa or below, using a glass tube oven (manufactured by Sibata Scientific Technology Ltd.) as a nonexposure vacuum drying apparatus. The composite active material particle was collected into a glove box of an Ar atmosphere (dew point: no more than −70° C.) without exposed to the atmosphere.

### 3.2. Example 2

Moisture was removed, and the composite active material particle was collected in the same way as Example 1 except that the time for vacuum drying was 5 hours.

### 3.3. Example 3

Moisture was removed, and the composite active material particle was collected in the same way as Example 1 except that the time for vacuum drying was 10 hours.

### 3.4. Example 4

Moisture was removed, and the composite active material particle was collected in the same way as Example 1 except that the time for vacuum drying was 20 hours.

### 3.5. Example 5

Moisture was removed, and the composite active material particle was collected in the same way as Example 1 except that the temperature for vacuum drying was 120° C., and the time for vacuum drying was 5 hours.

### 3.6. Example 6

Example 6 was same as Example 2. That is, moisture was removed, and the composite active material particle was collected in the same way as Example 1 except that the time for vacuum drying was 5 hours.

### 3.7. Example 7

Moisture was removed, and the composite active material particle was collected in the same way as Example 1 except that the temperature for vacuum drying was 250° C., and the time for vacuum drying was 5 hours.

### 3.8. Example 8

Moisture was removed, and the composite active material particle was collected in the same way as Example 1 except that the temperature for vacuum drying was 300° C., and the time for vacuum drying was 5 hours.

### 3.9. Comparative Examples 1 and 2

The composite active material particle before moisture was removed was collected as it was.

### 4. Making Cathode and all-Solid-State Lithium Ion Battery

### 4.1. Examples 1 to 4, and Comparative Example 1

The collected composite active material particle, a sulfide solid electrolyte (Li3PS4), 3 mass % of VGCF (manufactured by Showa Denko K.K.) as conductive material, and 0.7 mass % of butylene rubber (manufactured by JSR Corporation) as a binder were loaded into heptane, to make a cathode mixture slurry. After the made slurry was dispersed by an ultrasonic homogenizer, aluminum foil was coated therewith, dried at 100° C. for 30 minutes, and then blanked out into a size of 1 cm², to obtain a cathode. The volume ratio of the composite active material particle to the sulfide solid electrolyte was 6:4.

Anode active material (layered carbon), the sulfide solid electrolyte, and 1.2 mass % of butylene rubber were loaded into heptane, to make an anode mixture slurry. After the made slurry was dispersed by an ultrasonic homogenizer, copper foil was coated therewith, dried at 100° C. for 30 minutes, and then blanked out into a size of 1 cm², to obtain an anode. The volume ratio of the anode active material particle to the sulfide solid electrolyte was 6:4.

Into a tubular ceramic of 1 cm² in inner diameter cross section, 64.8 mg of the sulfide solid electrolyte was loaded, smoothed, and thereafter pressed at 1 ton, to form the solid electrolyte layer.

The cathode was superposed on one face of the solid electrolyte layer, and the anode was superposed on the other face thereof. After the resultant was pressed at 4.3 ton for 1 minute, a stainless bar was put into both of the cathode and anode, which was constrained at 1 ton, to make an all-solid-state lithium ion battery.

### 4.2. Examples 5 to 8, and Comparative Example 2

An all-solid-state lithium ion battery was produced in the same procedures as the above except that Li3PS4-LiI was used as the sulfide solid electrolyte instead of Li3PS4, and the volume ratio of the active material particle to the sulfide solid electrolyte in both of the cathode and the anode was 4:6.

Table 1 below shows conditions for vacuum drying (temperature and time), types of the sulfide solid electrolyte, and the volume ratio of the active material particle to the sulfide solid electrolyte in every example and comparative example.

TABLE 1

| | | | | Volume Ratio |
|---|---|---|---|---|
| | | | | of Active |
| | Conditions for | | | Material |
| | Vacuum Drying | | Type of | Particle to |
| | Temperature | Time | Sulfide Solid | Sulfide Solid |
| | (° C.) | (h) | Electrolyte | Electrolyte |
| Comp. Ex. 1 | None | None | Li3PS4 | 6:4 |
| Ex. 1 | 200 | 1 | Li3PS4 | 6:4 |
| Ex. 2 | 200 | 5 | Li3PS4 | 6:4 |
| Ex. 3 | 200 | 10 | Li3PS4 | 6:4 |
| Ex. 4 | 200 | 20 | Li3PS4 | 6:4 |
| Comp. Ex. 2 | None | None | Li3PS4-LiI | 4:6 |
| Ex. 5 | 120 | 5 | Li3PS4-LiI | 4:6 |
| Ex. 6 | 200 | 5 | Li3PS4-LiI | 4:6 |
| Ex. 7 | 250 | 5 | Li3PS4-LiI | 4:6 |
| Ex. 8 | 300 | 5 | Li3PS4-LiI | 4:6 |

### 5. Evaluation of all-Solid-State Lithium Ion Battery

The batteries according to the examples and comparative examples were charged to 4.55 V, and after that discharged to 2.5 V in voltage. Thereafter, resistance at 3.6 V was measured by an AC impedance method. Upon evaluation, suppose that the resistance of the battery according to Comparative Example 1 was 100, and the resistance of the batteries according to Examples 1 to 4 was referenced as “resistance ratio”. Suppose that the resistance of the battery according to Comparative Example 2 was 100, and the resistance of the batteries according to Examples 5 to 8 was referenced as “resistance ratio” as well. The results are shown in Table 2 below.

### 6. Moisture Content Measurement

The moisture content in the composite active material particle according to every example and comparative example was measured by Karl Fischer titration. Specifically, moisture that was released from the composite active material particle at a heating part of a trace level moisture measurement device (manufactured by Hiranuma Sangyo Co., Ltd.), whose temperature was set at 200° C., was made to flow to a measuring part thereof, using a nitrogen gas as a carrier, to measure the moisture content. The measurement time was 40 minutes. The results are shown in Table 2 below.

TABLE 2

| | Conditions for | | | |
|---|---|---|---|---|
| | Vacuum Drying | | Moisture | Resistance |
| | Temperature | Time | Content | Ratio |
| | (° C.) | (h) | (ppm) | (%) |
| Comp. Ex. 1 | None | None | 402 | 100 |
| Ex. 1 | 200 | 1 | 119 | 77 |
| Ex. 2 | 200 | 5 | 70 | 58 |
| Ex. 3 | 200 | 10 | 49 | 54 |
| Ex. 4 | 200 | 20 | 51 | 48 |
| Comp. Ex. 2 | None | None | 402 | 100 |
| Ex. 5 | 120 | 5 | 319 | 89 |
| Ex. 6 | 200 | 5 | 70 | 70 |
| Ex. 7 | 250 | 5 | 54 | 70 |
| Ex. 8 | 300 | 5 | 61 | 92 |

As shown in Table 2, it is found that the moisture contents in the composite active material particles according to Examples 1 to 8, from which moisture was removed by vacuum drying, can be remarkably reduced compared with those according to Comparative Examples 1 and 2, from which moisture was not removed. The resistance of the batteries according to Examples 1 to 8 remarkably decreased more than those according to Comparative Examples 1 and 2. The effect of vacuum drying can be considered as follows: that is, moisture contained in the composite active material particle was largely removed, which led to suppression of deterioration of the sulfide solid electrolyte, which was in contact with the composite active material particle, due to moisture in the battery. Whereby, it is considered that conductivity of the sulfide solid electrolyte was kept high, and as a result, the battery resistance decreased.

### 7. Case of Using Alkoxide Solution (Comparative Example 3)

### 7.1. Preparing Alkoxide Solution

An alkoxide solution was made by using ethoxylithium, pentaethoxyniobium, and dehydrated ethanol. After ethoxylithium was dissolved in, and uniformly dispersed over dehydrated ethanol, pentaethoxyniobium was loaded thereto so that the element ratio of lithium to niobium was 1:1, and stirred until uniformly mixed. Here, the loading amount of ethoxylithium was adjusted so that the proportion of the solid in the solution was 6.9 wt %.

### 7.2. Spraying Over and Calcining Active Material Particle

Over 1 kg of the active material particle, 680 g of the alkoxide solution prepared as the above was sprayed. Driving conditions were: the atmosphere was used as an intake gas; intake gas temperature was 80° C.; the intake gas flow was 0.3 m³/min; the rotating speed of a rotor was 300 rpm; and the spraying speed was 1.5 g/min After completion of the driving, the resultant was calcined in the atmosphere at 350° C. for 5 hours, to obtain a composite active material particle according to Comparative Example 3.

### 7.3. Moisture Content Measurement

The moisture content in the obtained composite active material particle was measured by Karl Fischer titration in the same way as Examples 1 to 8 and Comparative Examples 1 and 2. The moisture content therein was 1367 ppm.

As is clear from Comparative Example 3, moisture contained in the composite active material particle was a lot even when the particle was produced using the alkoxide solution. It is considered that moisture remained in the particle, accompanying decomposition reaction when a coating layer was formed. Thus, it is clear that when an alkoxide solution is used, the problem same as in the case of using a peroxo complex solution (deterioration of the sulfide solid electrolyte due to moisture) arises as well. In this point, it is obvious that the battery resistance can be reduced by reducing the moisture content in the composite active material particle by vacuum drying as Examples 1 to 8.

### INDUSTRIAL APPLICABILITY

For example, the composite active material particle of the present disclosure can be applied as a cathode active material particle for all-solid-state lithium ion batteries. Such all-solid-state lithium ion batteries can be used as onboard large-sized power sources. Such all-solid-state lithium ion batteries can be applied as emergency power supplies, and commercial batteries as well.

### REFERENCE SIGNS LIST

1 active material particle
2 lithium ion conducting oxide
10 composite active material particle
11 sulfide solid electrolyte
12 conductive material
13 binder
20 cathode
20a cathode mixture layer
20b cathode collector
30 solid electrolyte layer
40 anode
41 anode active material
42 solid electrolyte
43 binder
100 all-solid-state lithium ion battery

What is claimed is:

1. A method for producing a composite active material particle, the method comprising:
a first step of coating at least part of a surface of an active material particle with a lithium ion conducting oxide, to form a coated active material particle; and
a second step of drying the coated active material particle obtained in the first step in a vacuum at a temperature of 120° C. to 300° C. for at least 1 hour.

2. The method according to claim 1, wherein
in the first step, a precursor is obtained by drying a peroxo complex aqueous solution that contains (an) element(s) constituting the lithium ion conducting oxide on the surface of the active material particle, and the coated active material particle is formed by calcining the precursor.

3. A method for producing a cathode, the method comprising:
a step of obtaining a cathode mixture by mixing the composite active material particle produced in the method according to claim 1, with a sulfide solid electrolyte, and
a step of shaping the cathode mixture.

4. A method for producing an all-solid-state lithium ion battery, the method comprising:
a step of layering the cathode produced by the method according to claim 3, a solid electrolyte layer, and an anode.

5. A method for producing a composite active material particle, the method comprising:
a first step of coating at least part of a surface of an active material particle with a lithium ion conducting oxide, and drying and calcining the resultant particle, to form a coated active material particle; and
a second step of drying the resultant coated active material particle obtained in the first step in a vacuum at a temperature of 120° C. to 300° C. for at least 1 hour, wherein
the lithium ion conducting oxide is at least one selected from lithium niobate, lithium titanate, lithium lanthanum zirconate, lithium tantalate, and lithium tungstate, and
the composite active material particle obtained in the second step is used for a cathode of an all-solid-state lithium ion battery provided with a sulfide solid electrolyte.

6. A method for producing a cathode, the method comprising:
a step of obtaining a cathode mixture by mixing the composite active material particle produced in the method according to claim 5, with a sulfide solid electrolyte, and
a step of shaping the cathode mixture.

7. A method for producing an all-solid-state lithium ion battery, the method comprising:
a step of layering the cathode produced by the method according to claim 6, a solid electrolyte layer, and an anode.
